(19) United States
(12) Patent Application Publication
(10) Pub. No.: US 2016/0023754 A1
(43) Pub. Date: Jan. 28, 2016

(54) Vertical take-off aircraft

(71) Applicant: Lilium GmbH, Gilching (DE)

(72) Inventor: Daniel Wiegand, Munchen (DE)

(21) Appl. No.: 14/794,078

(22) Filed: Jul. 8, 2015

(30) Foreign Application Priority Data
Jul. 8, 2014 (DE) 10 2014 213 215.0

(51) Int. Cl. B64C 27/26; B64C 27/22; B64C 29/00; B64C 3/56; B64C 27/52; B64C 27/20

(52) U.S. Cl. CPC B64C 27/26; B64C 27/52; B64C 27/20; B64C 29/00; B64C 3/56; B64C 27/22

(57) ABSTRACT

A mechanism for stowing and/or adjusting a ducted propeller of a flying object, the flying object comprising a fuselage and at least one pair of wings, the outer walls of which together define a shell of the flying object, comprising a ducted propeller comprising a substantially cylindrical duct, which defines a longitudinal axis of the ducted propeller and is open at the base faces thereof, a rotor comprising a plurality of rotor blades, which is set up to rotate in a plane perpendicular to the longitudinal axis of the ducted propeller, and a drive device for driving the rotor; a receiving chamber, provided in the fuselage and/or a wing of the flying object, for the ducted propeller; a mechanism which is set up to transfer the ducted propeller from a stowed state into a deployed state.

The present invention relates completely generally to improvements in the field of flying objects having vertical take-off and landing (VTOL) capability and to improved ducted propellers which can be used for example in said flying objects.

Aeroplanes having the capability for vertical take-off and landing have the potential to combine the advantages of helicopters, namely take-off and landing on a limited space and/or in poorly accessible terrain, with the advantages of conventional aeroplanes, such as high possible cruise speed and energy-efficient flight. In the last few decades, significant progress has been made in the field of aeroplanes having vertical take-off and landing capability, but thus far a broad-based economic breakthrough has not been achieved.

In particular the generation of a sufficient vertical thrust for vertical take-off of an aeroplane of this type and of a sufficient propulsion thrust in normal horizontal flight (cruising) pose challenges which are hard to meet and for which a wide range of solution approaches have been proposed. For example, reference may be made to the drive systems set out in U.S. Pat. No. 3,488,018 and U.S. Pat. No. 3,700,189, which combine the vertical thrust generation for take-off and the horizontal thrust generation for cruising in various manners.

One of the main challenges in the construction of an aeroplane with the capability for vertical take-off and landing is that, on the one hand, large propeller areas are needed for it to be possible to generate a sufficient mass flow for the thrust generation in the vertical direction for take-off and landing, and for the energy consumption simultaneously to remain in an acceptable range. On the other hand, when the aeroplane is cruising the lift force is generated dynamically, generally by suitable wing profiles, and this means that the aforementioned large propellers have to be stowed in such a way that they produce as little aerodynamic resistance as possible during cruising.

Ducted propellers (ducted fans) are particularly suitable for this purpose, and have a range of advantages over freely rotating propellers. On the one hand, ducted propellers provide more thrust for the same area flowed through and the same shaft power, and are much quieter; on the other hand, they are also safer, since in ducted propellers the rotor blades are much better protected against external effects than in freely rotating propellers. A drawback of ducted propellers is that unlike free propellers they are not foldable and therefore require more stowing space than freely rotating, foldable propellers in an aeroplane with vertical take-off and landing capability.

Therefore, a first aspect of the invention provides a mechanism for stowing and/or adjusting a ducted propeller of a flying object, which solves the aforementioned problem and is suitable, by way of example and non-exclusively, for use in a flying object having vertical take-off and landing capability. In this context, the flying object comprises a fuselage and at least one pair of wings, the outer walls of which together define a shell of the flying object. The mechanism for stowing and/or adjustment comprises a ducted propeller which in turn comprises a substantially cylindrical duct, which defines a longitudinal axis of the ducted propeller and is open at the base faces thereof, a rotor comprising a plurality of rotor blades, which is set up to rotate in a plane perpendicular to the longitudinal axis of the ducted propeller, and a drive device for driving the rotor. The mechanism for stowing and/or adjustment further comprises a receiving chamber, provided in the fuselage and/or a wing of the flying object, for the ducted propeller and a mechanism which is set up to transfer the ducted propeller from a stowed state into a deployed state. In this context, in the stowed state the ducted propeller is received in the receiving chamber in such a way that as considered in a longitudinal direction of the flying object it is received completely within the shell of the flying object. Further, according to the invention, in the deployed state at least the base faces of the duct of the ducted propeller are positioned outside the shell of the flying object and the longitudinal axis of the ducted propeller is tilted towards the longitudinal axis of the flying object through a variable angle, between 0 degrees and 90 degrees, with respect to a pitch axis of the flying object.

A mechanism of this type according to the invention makes it possible, on the one hand, to align a ducted propeller both to generate a thrust in the vertical direction and to generate a thrust in both the vertical and the horizontal direction and, on the other hand, to receive it completely in the shell of the flying object, where it does not contribute to the effective air resistance of the flying object in a cruising configuration.

In this context, the concept of the aeroplane shell refers to the outline of the flying object defined by the outer skin of the aeroplane fuselage and of the wings, whilst attachments additionally provided on the flying object, such as gondola engines, are not counted as part of the shell of the flying object.

According to the invention, the concept of the cylindrical duct should be understood broadly and not as limited to a purely geometrically correct definition. In particular, the duct of the ducted propeller is not restricted to a circular cylinder shape, and the two base faces of the duct also need not necessarily be planar, but rather the duct of the ducted propeller may comprise profiling in the region of the base faces. Further, it is not necessary for the duct to be of a constant circumference over the length thereof, but rather it may also for example be funnel-shaped or formed with a bulge.

Further, it is even conceivable for the duct of the ducted propeller likewise substantially to have a cylindrical shape, in accordance with the above definition, with respect to a further axis perpendicular to the longitudinal axis thereof. Because of the increased symmetry thereof, a “double cylinder” of this type may be used particularly flexibly and stowed compactly.

Both in the above description of the first aspect of the present invention and in all further aspects, the term “longitudinal direction” of the flying object denotes a direction extending from the front to the tail of the flying object and substantially corresponding to the roll axis of the flying object during cruising. The pitch axis and the yaw axis of the flying object are each perpendicular to the longitudinal direction of the flying object, the yaw axis substantially corresponding to the vertical axis of the flying object and the pitch axis substantially corresponding to the transverse axis of the flying object.

The orientation of the longitudinal axes of the flying object and ducted propeller may be selected freely in the first position; for example, the two longitudinal axes may be substantially mutually parallel.

According to the invention, the mechanism for stowing and/or adjusting the ducted propeller always transmits the thrust generated by the ducted propeller to the flying object.

In one embodiment, the transfer mechanism may comprise a first mechanism which is set up to pivot the ducted propeller about a first pivot axis which is substantially parallel to the longitudinal axis of the flying object and a second mechanism which is set up to pivot the ducted propeller about a second pivot axis at an inclination to the first axis. In this context, the first pivot axis may preferably be outside the ducted propeller or in the region of the duct of the ducted propeller.

A mechanism formed in accordance with this embodiment has a very low space requirement in the fuselage of the flying object, and this makes an advantageous overall configuration of the flying object possible.

In a mechanism in accordance with this embodiment, the second pivot axis may be parallel to the pitch axis of the flying object. As a result, by varying the pivot angle about the second pivot axis between 0 degrees and 90 degrees with respect to the longitudinal direction of the flying object, the thrust generated by the ducted propeller during operation can be adjusted continuously between a state in which it is merely used for propulsion of the flying object and a state in which it is merely used for lift of the flying object.

Further, in a mechanism in accordance with the embodiment, the ducted propeller may comprise a stator which has one or more substantially radially extending stator blades, and the second pivot axis may be arranged within the ducted propeller and in the region of the stator with respect to the longitudinal direction of the ducted propeller. As a result of this arrangement of the second pivot axis, a particularly preferred take-up of the thrust force by the transfer mechanism can be provided.

In this context, completely generally, all of the parts of the stator, including the at least one stator blade, are stationary with respect to the duct of the ducted propeller, and the stator can thus be considered a “fixed component” of the ducted propeller.

In an alternative embodiment, the transfer mechanism may comprise a retraction/deployment mechanism, which is set up to retract/deploy the ducted propeller radially linearly in a first direction with respect to the longitudinal axis of the flying object, and a pivot mechanism, which is set up to pivot the ducted propeller about a pivot axis which is parallel to the first direction. In particular, the first direction may be parallel to the pitch axis of the flying object.

In a preferred embodiment, the retraction/deployment mechanism may comprise a first support element, which is associated with the fuselage of the flying object and extends in the first direction, and a second support element, which is associated with the ducted propeller, extends in the first direction and is movable a predetermined distance in the first direction relative to the first support element. In this embodiment, the first support element and the second support element are set up to cooperate in such a way that in the stowed state of the ducted propeller they overlap by at least a first predetermined amount with respect to the first direction and in such a way that in the deployed state they overlap by a second amount, smaller than the first predetermined amount, with respect to the first direction and transfer propulsion/lift forces generated by the ducted propeller to the flying object. In this context, the second amount may in particular even be zero, in other words it is conceivable for there no longer to be any overlap between the first and second support element in the deployed state.

Providing an overlap of the first support element and the second support element in the stowed state makes a particularly compact configuration of the retraction/deployment mechanism possible in the fuselage of the flying object.

Further, the first and second support element may each be provided with elements which cooperate in such a way that a movement of the second support element with respect to the first support element in the first direction brings about the pivoting of the ducted propeller, at least over part of the predetermined distance. For this purpose, any desired cooperating elements may be provided which are capable of converting a translational movement into a rotational movement. One possible example would be a curved slot in which a cam is guided, it being possible for the slot and the cam each to be associated with the first or second support element.

In a further preferred embodiment of the mechanism in accordance with the embodiment, the ducted propeller may further comprise a stator which has one or more substantially radially extending stator blades. In this context, the second support element may accordingly be arranged in the region of the stator, preferably within at least one stator blade, at least in part with respect to the longitudinal direction of the ducted propeller.

For example, the first support element may be formed as a rod and the second support element as a hollow rod or the first support element as a hollow rod and the second support element as a rod, the rod being formed substantially completely within the hollow rod in the stowed state. This embodiment of the retraction/deployment mechanism combines the advantages of a compact construction in the stowed state and an optimum force take-up in the deployed state.

In the two aforementioned embodiments, in the stowed state of the ducted propeller the shell of the flying object may be formed at least in part by the duct of the ducted propeller and/or by a cover element in the region of the receiving chamber, the cover element optionally also being able to form part of the shell in the deployed state. In this context, for example a flap is conceivable which opens for the deployment of the ducted propeller and closes again after deployment is completed. Both forming part of the shell of the flying object using the duct of the ducted propeller and providing a cover element make it possible to achieve advantageous flow properties of the flying object both in the stowed state and in the deployed state of the ducted propeller.

A second aspect of the present invention relates to an electrically driven ducted propeller which can be provided for example for use in a flying object having vertical take-off and landing capability and which may optionally be used in connection with a mechanism in accordance with the first aspect of the invention. According to the invention, the electrically driven ducted propeller comprises a duct having a substantially circular internal cross-section, a stator rotationally engaged with the duct, having one or more substantially radially extending stator blades and having on a radially inner region a shaft for supporting a rotor, a rotor supported on the shaft rotatably with respect to the stator and the duct and having a plurality of rotor blades, a plurality of magnets rotationally engaged with the rotor or a conductive cage rotationally engaged with the rotor, and a plurality of coils arranged rotationally engaged with respect to the stator and the duct. According to the invention, the rotor comprises a plurality of additional blades rigidly connected to the rotor in a radial end region, the radial end region of the rotor which comprises the additional blades facing towards the plurality of coils.

In this context, the electrical drive of the ducted propeller corresponds to a synchronous or asynchronous machine depending on whether the plurality of magnets or the conductive cage is associated with the rotor.

As a result of the additional blades being provided in a radial end region of the rotor, the airflow generated by the rotor can advantageously be shaped in this region. In particular, the plurality of additional blades may be formed in such a way that they deflect part of the air sucked in by the rotor towards the coils in such a way that the coils are cooled by the resulting airflow. This improved cooling of the coils makes a higher power of the ducted propeller possible, since for example a high provided rotational speed of the rotor requires a high switching frequency of the coils, which in turn leads to increased heat losses in the coils and in particular the cores, for example made of iron, of the coils, which losses have to be dissipated suitably so as to prevent damage to the coils.

A third aspect of the present invention relates to an electrically driven ducted propeller, which may for example be used in a flying object having vertical take-off and landing capability, may optionally be used in connection with a mechanism in accordance with the first aspect of the invention, and may optionally be combined with the second aspect of the invention. In this context, the ducted propeller comprises a duct having a substantially circular internal cross section, a stator rotationally engaged with the duct, having one or more substantially radially extending stator blades and having on a radially inner region a shaft for supporting a rotor, a rotor supported on the shaft rotatably with respect to the stator and the duct and having a plurality of rotor blades, a plurality of magnets rotationally engaged with the rotor or a conductive cage rotationally engaged with the rotor, and a plurality of coils arranged rotationally engaged with respect to the stator and the duct. According to the invention, a deflector element is provided upstream from the rotor blades with respect to the flow direction of air sucked in through the ducted propeller, and covers both the magnets of the rotor or the conductive cage and the coils as considered in the flow direction, the coils being arranged in such a way that they can be flowed onto during the operation of the ducted propeller by air flowing around the deflector element.

Providing a deflector element prevents foreign substances sucked in by the ducted propeller from reaching the region between the rotor and the coils, since these substances can damage the coils in particular. The foreign substances may for example be sand or the like which is swirled up by the ducted propeller itself and which is sucked into the region of the rotor together with the airflow sucked in by the ducted propeller.

Both in a ducted propeller in accordance with the second aspect of the invention and in one in accordance with the third aspect of the invention, the radially outer ends of the rotor blades may be connected by a peripheral ring. This measure provides improved force distribution of the forces acting on the rotor during operation. Further, this results in the possibility of at least some of the plurality of magnets or at least part of the conductive cage being able to be received in or supported by the peripheral ring.

As a result of this arrangement, it can be provided that the centrifugal forces acting on the magnets received in or supported by the peripheral ring or on the part of the conductive cage received in or supported on the ring are distributed uniformly over the ring and thus do not act on the rotor blades, whilst the rotor blades merely have to absorb the torsional forces used to drive them.

A fourth aspect of the present invention relates to an electrically driven ducted propeller, which may for example be used in a flying object having vertical take-off and landing capability and may optionally be used in connection with a mechanism in accordance with the first aspect of the invention, and which may optionally have further features of the second and third aspects of the invention. The ducted propeller in accordance with the fourth aspect of the invention comprises a duct having a substantially circular internal cross section, a stator rotationally engaged with the duct, having one or more substantially radially extending stator blades and having on a radially inner region a shaft for supporting a rotor, a rotor supported on the shaft rotatably with respect to the stator and the duct and having a plurality of rotor blades, a plurality of magnets rotationally engaged with the rotor or a conductive cage rotationally engaged with the rotor, and a plurality of coils arranged rotationally engaged with respect to the stator and the duct. In accordance with the fourth aspect of the invention, the shaft for supporting the rotor is a hollow shaft which defines a substantially cylindrical interior which is open at both base faces.

As a result of the selection according to the invention of a hollow shaft for supporting the rotor, on the one hand, the airflow formed by the ducted propeller can be optimally guided, and, on the other hand, both the at least one stator blade and the rotor blades can be selected to be shorter, leading to a reduced weight and an increased rigidity of the ducted propeller.

In an advantageous embodiment, the coils may further be attached to the hollow shaft and cooling ribs may be provided on the radial inner face of the hollow shaft, leading to excellent cooling of the coils along with the advantages discussed in relation to the third aspect of the invention.

A fifth aspect of the invention relates to an electrically driven ducted propeller, which may for example be used in a flying object having vertical take-off and landing capability and may optionally be used in connection with a mechanism in accordance with the first aspect of the invention, and which may optionally have further features of the second to fourth aspects of the invention. The ducted propeller in accordance with the fifth aspect of the invention comprises a duct having a substantially circular internal cross section, a stator rotationally engaged with the duct, having one or more substantially radially extending stator blades and having on a radially inner region a shaft for supporting a rotor, a rotor supported on the shaft rotatably with respect to the stator and the duct and having a plurality of rotor blades, a plurality of magnets rotationally engaged with the rotor or a conductive cage rotationally engaged with the rotor, and a plurality of coils arranged rotationally engaged with respect to the stator and the duct. In accordance with the fifth aspect of the invention, the rotor is supported on the shaft using a four-point bearing, said four-point bearing being arranged along an individual peripheral circle of the shaft.

As a result of the use and suitable arrangement of a four-point bearing, the construction of the ducted propeller is simplified and weight is saved without detracting from the structural properties of the ducted propeller.

A sixth aspect of the present invention relates to a flying object having vertical take-off and landing capability, comprising a plurality of ducted propellers, which each comprise a substantially cylindrical duct which defines a longitudinal axis of the ducted propeller and is open at the base faces thereof. In this context, the ducted propellers are each mounted rotatably about a pitch axis of the flying object and can each take on a first position, in which the longitudinal axis of the respective ducted propeller is parallel to the longitudinal axis of the flying object, and a second position, in which the longitudinal axis of the respective ducted propeller is at an inclination to the longitudinal axis by a particular angular amount. In this context, the ducted propellers are arranged in at least one row, each row comprising a plurality of ducted propellers, in such a way that when all of the ducted propellers in a row are in the first position the ducts of the ducted propellers form an overall cylinder. According to the invention, in the first position the ducts of at least two of the ducted propellers in the or each row of ducted propellers follow one another without interruption along the longitudinal axes thereof.

This configuration of the ducted propellers in the first position thereof leads, on the one hand, to optimal use of space in each of the rows with respect to the longitudinal axes thereof, resulting in a reduced weight and reduced size and, on the other hand, also to a flow-optimised shape of the overall cylinder which is formed by a plurality of duct cylinders in the first position of the duct cylinders.

If a row of duct cylinders consists of at least three duct cylinders, a configuration is in particular conceivable in which the ducts of at least three ducted propellers follow one another along the longitudinal axes thereof without interruption, in other words the duct of at least the central ducted propeller of the row transitions into the duct of the adjacent ducted propeller without interruption in each case in both directions along the longitudinal axis thereof. If the row comprises more than three ducted propellers, accordingly the ducts of a plurality of ducted propellers can transition into the duct of the adjacent ducted propeller without interruption in each case in both directions along the longitudinal axes thereof.

In a preferred embodiment, a start element may be associated with the or each row of ducted propellers in the longitudinal direction of the flying object and be formed in such a way that in the first position of the ducted propellers, as considered in the longitudinal direction of the flying object, the base face of the overall cylinder formed by the ducts of the ducted propellers is covered in a front view.

Alternatively or in addition, an end element may further be associated with the or each row of ducted propellers in the longitudinal direction of the flying object, and be formed in such a way that in the first position of the ducted propellers, as considered in the longitudinal direction of the flying object, the base face of the overall cylinder formed by the ducts of the ducted propellers is covered in a rear view.

As a result of a start and/or end element being provided, an advantageous flow of air around the row or along the row can be achieved.

Both the start and the end element may either be formed by a dedicated component, for example provided on the fuselage of the flying object, or be formed by front and rear wing edges, for example if the row of ducted propellers is provided in a wing of the flying object.

In a preferred embodiment, in each case at least one base face of each ducted propeller may be formed S-shaped in a side view along the pitch axis of the flying body, the S shape preferably following the circulation of the longitudinal axis of the ducted propeller about the pitch axis of the flying body.

In this connection, it should again be noted that the concept “cylindrical” is to be interpreted broadly for the ducts of the ducted propellers, and that the base faces which are formed S-shaped do not conflict with the cylindrical shape. The S-shape, following the circulation of the longitudinal axis of the ducted propeller, of the base faces of the ducts makes a seamless transition of the ducts possible in the first state of the ducted propellers as well as an optimum flow onto the ducted propellers in the second state. Further, as a result of the stated geometry of the ducts, it may also be possible to pivot each of the ducted propellers individually, and this is advantageous in particular in relation to redundancy and safety issues.

In one possible embodiment, at least some of the ducted propellers may be arranged directly on an outer face of a fuselage of the flying object.

Alternatively or in addition, at least some of the ducted propellers may further be arranged in a wing of the flying object, the ducts of the ducted propellers arranged in the wings preferably forming part of the wing profile in the first position. In this connection, the broad definition of the term “cylindrical duct” should again be noted.

According to the invention, a flying object in accordance with the sixth aspect of the invention may further comprise at least one further ducted propeller and/or further devices which merely contribute to the propulsion of the flying object.

As a result of these measures, it can for example be provided that during cruising the flying object obtains its thrust exclusively from the devices merely provided for the propulsion of the flying object, and this makes it possible to use the ducted propellers arranged in sequence merely during a vertical take-off, a vertical landing and the transition from hovering operation into cruising operation, and to turn them off during cruising operation.

A seventh aspect of the invention relates to a flying object having vertical take-off and landing capability, which optionally comprises at least one mechanism in accordance with the first aspect of the invention and/or at least one ducted propeller in accordance with the second and/or third and/or fourth and/or fifth aspect and/or has further features of the flying object in accordance with the sixth aspect of the invention. The flying object in accordance with the seventh aspect of the invention comprises an undercarriage and at least one pair of wings, which can be slid or folded in a mode of travel of the flying object which can be implemented using the undercarriage on the base, the wings each being pivotable about an axis which is inclined by an angle of between 25 degrees and 65 degrees, preferably approximately 45 degrees, with respect to each of the primary axes of the flying object and which is provided directly on the wing attachment, or in that the wings are each pivotable about an axis which is positioned in the fuselage of the flying object and which is positioned in the plane spanned by the longitudinal axis and the pitch axis and which is tilted in each case through an angle of between approximately 25 degrees and approximately 65 degrees, preferably through approximately 45 degrees, towards the longitudinal axis and the pitch axis of the flying object, or in that the wings can be folded inwards into the fuselage, the fuselage being sealable by sealing elements, or in that the wings are retractable into the fuselage by means of a slide arrangement, or in that the wings are pivotable forwards or backwards using two articulations configured as a double articulation, a first pivot axis being positioned along a wingspan direction of the wing and a second pivot axis being positioned perpendicular to the first axis parallel to the yaw axis of the flying object, and the wing, for folding in, initially being pivoted through 90° about the first pivot axis and subsequently being pivoted forwards or backwards about the second pivot axis.

As a result of stowable or foldable wings being provided, the flying object gains considerable flexibility in a state in which it moves on the ground by means of its undercarriage, in particular since the width dimensions thereof are considerably reduced, meaning that it is made considerably simpler to manoeuvre and generally has a lower space requirement.

If one of the pivot axes of the wings extends along the respective wingspan direction of the individual wing, the function of an elevator or aileron can additionally be taken on by the wings by way of combined or coordinated pivoting of the wings of the flying object about this respective axis during flight. This makes it possible to improve the manoeuvrability of the flying object or to dispense completely with conventional elevators or ailerons and thus to simplify the construction of the flying object.

A eighth aspect of the invention relates to a flying object having vertical take-off and landing capability, which optionally comprises at least one mechanism in accordance with the first aspect of the invention and/or at least one ducted propeller in accordance with the second and/or third and/or fourth and/or fifth aspect of the invention and/or has further features of the flying object in accordance with the sixth and/or seventh aspect of the invention, and which comprises at least one ducted propeller, which is arranged in such a way that it is completely covered by a fuselage and/or a wing of the flying object in a front view of the flying object along the longitudinal axis of the flying object and is provided with controllable elements for thrust deflection, in such a way that in operation the ducted propeller can selectively contribute to the propulsion or lift or both to the propulsion or lift of the flying object.

Providing the ducted propeller in the “slipstream” of a fuselage or wing makes an advantageous flow onto the rotor of the ducted propeller possible, since the speed of the air sucked in is comparatively low and this increases the efficiency of the ducted propeller and in cooperation with the elements for thrust deflection leads to an increased performance and an improved vertical take-off and landing capability of the flying object.

In the following, the invention is described in greater detail with reference to the accompanying drawings by way of embodiments. In the drawings, in detail:

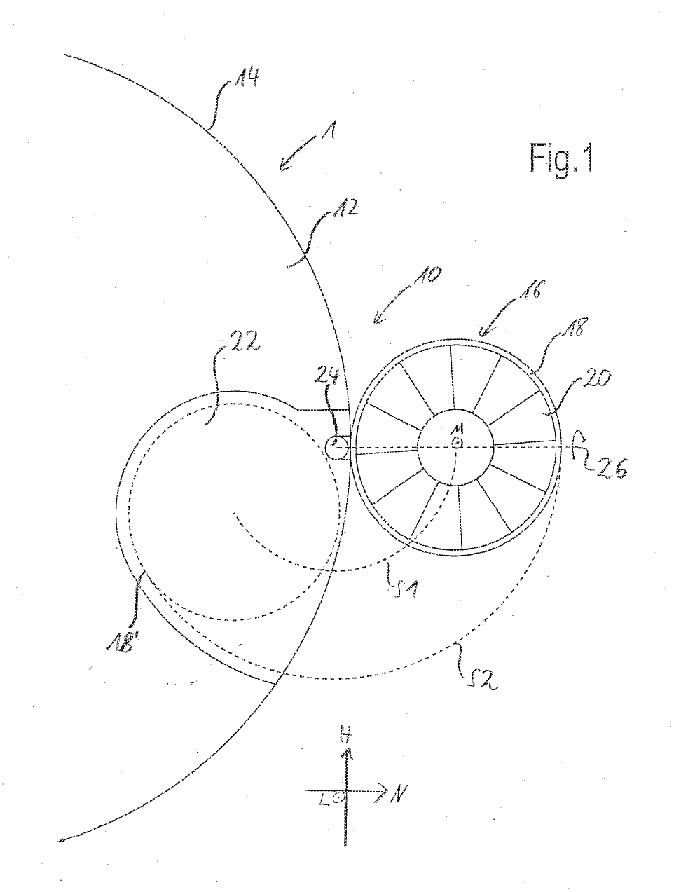

FIG. 1 is a cross-sectional view of a fuselage of a flying object comprising a mechanism according to the invention for stowing a ducted propeller in accordance with a first embodiment;

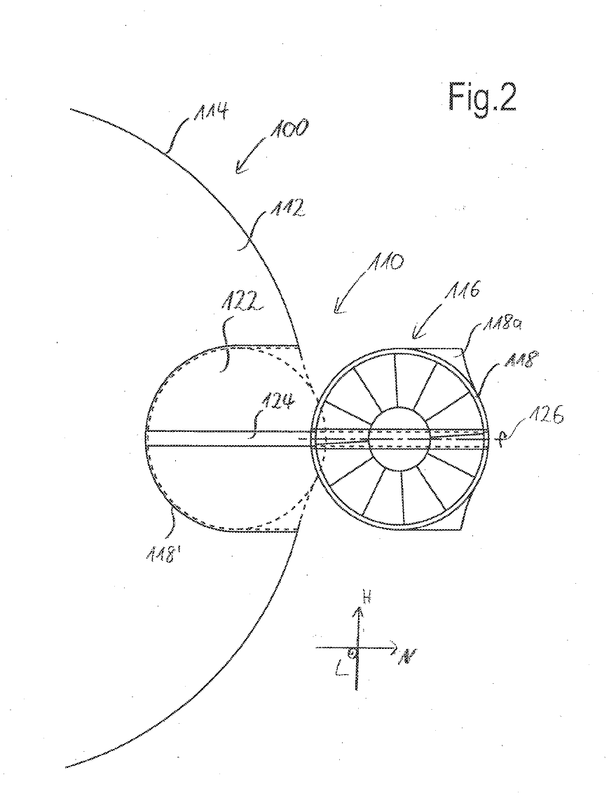

FIG. 2 is a cross section of a fuselage of a flying object comprising a mechanism according to the invention for stowing a ducted propeller in accordance with a second embodiment;

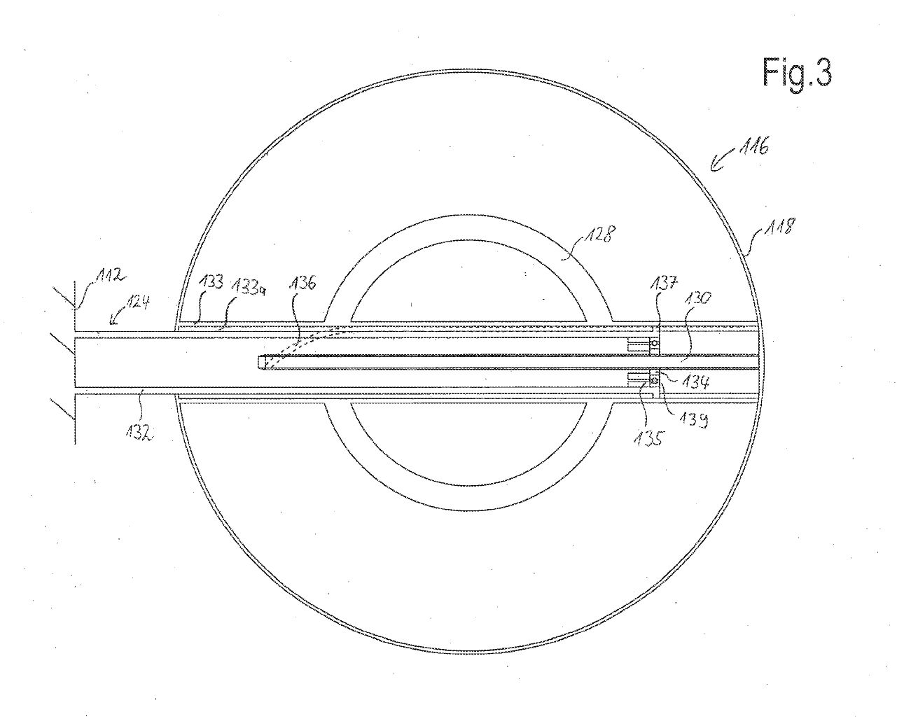

FIG. 3 is a cross section through a ducted propeller comprising a retraction/deployment mechanism in accordance with a first embodiment;

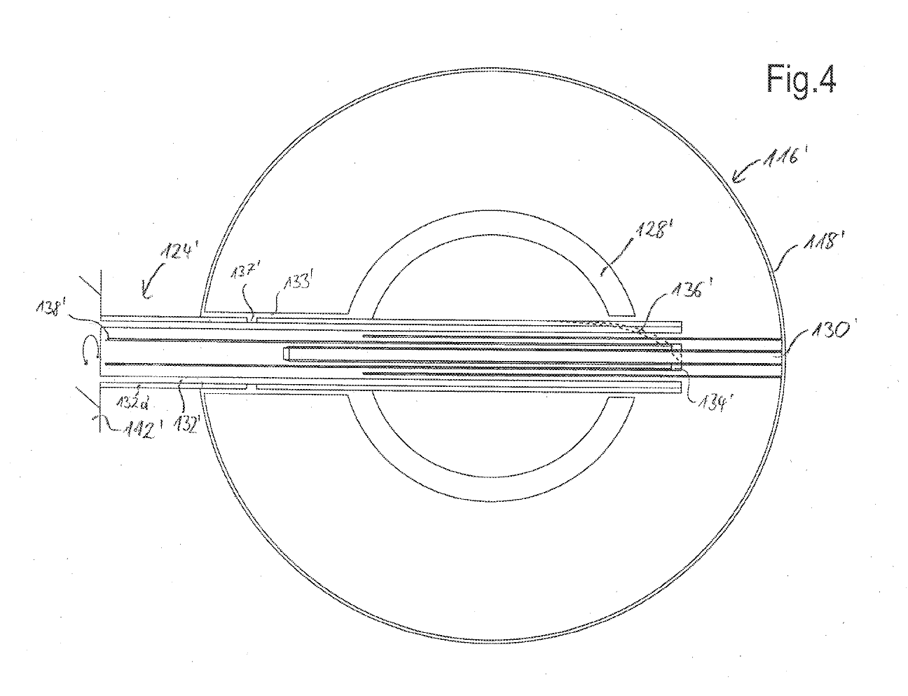

FIG. 4 is a cross section through a ducted propeller comprising a retraction/deployment mechanism in accordance with a second embodiment;

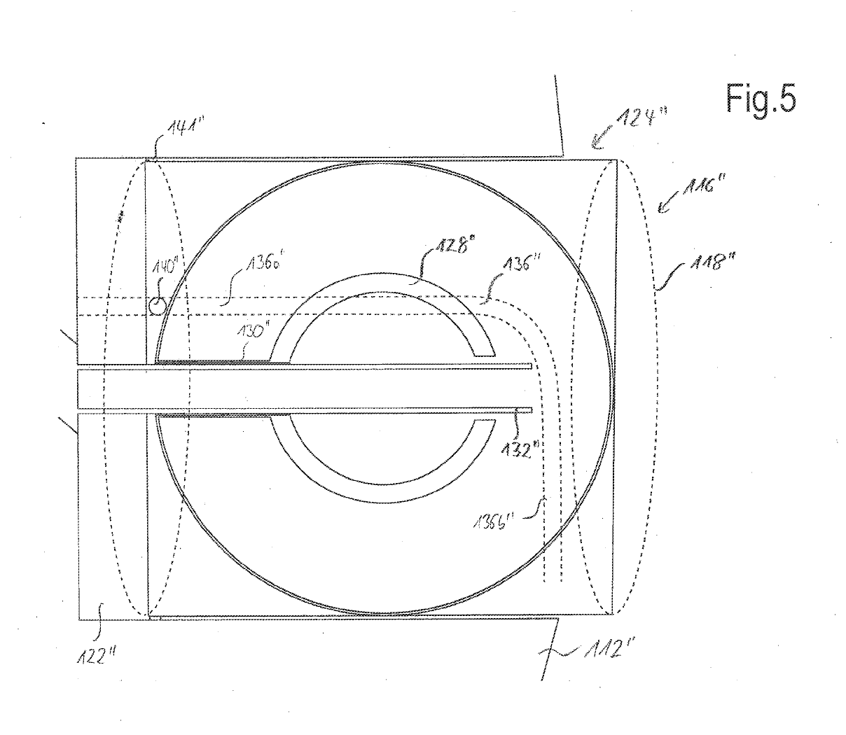

FIG. 5 is a cross section through a ducted propeller comprising a retraction/deployment mechanism in accordance with a third embodiment

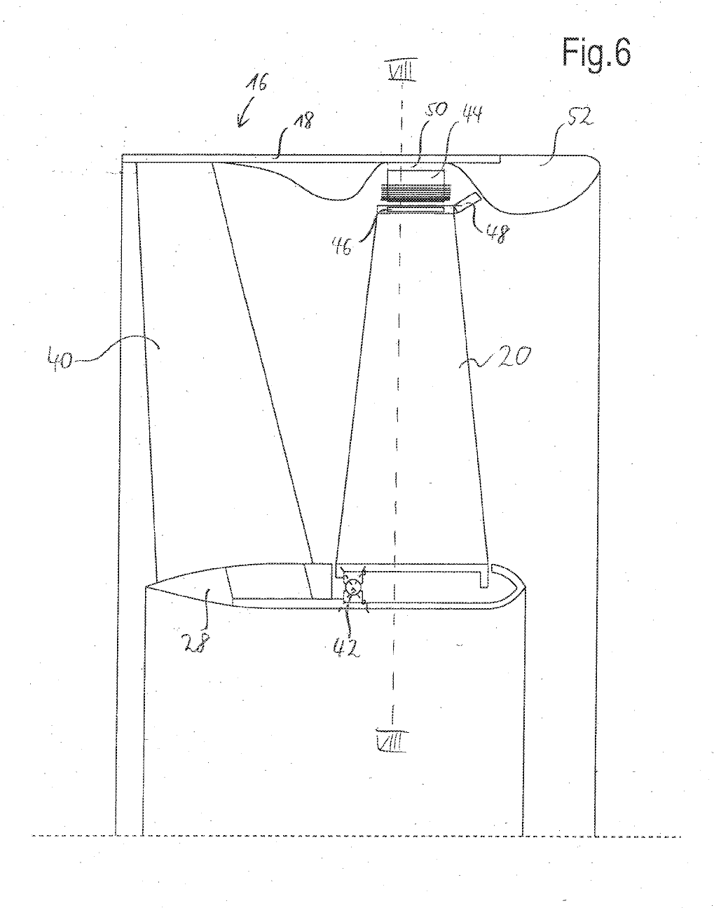

FIG. 6 is a longitudinal section through an electrically driven ducted propeller according to the invention in accordance with a first embodiment;

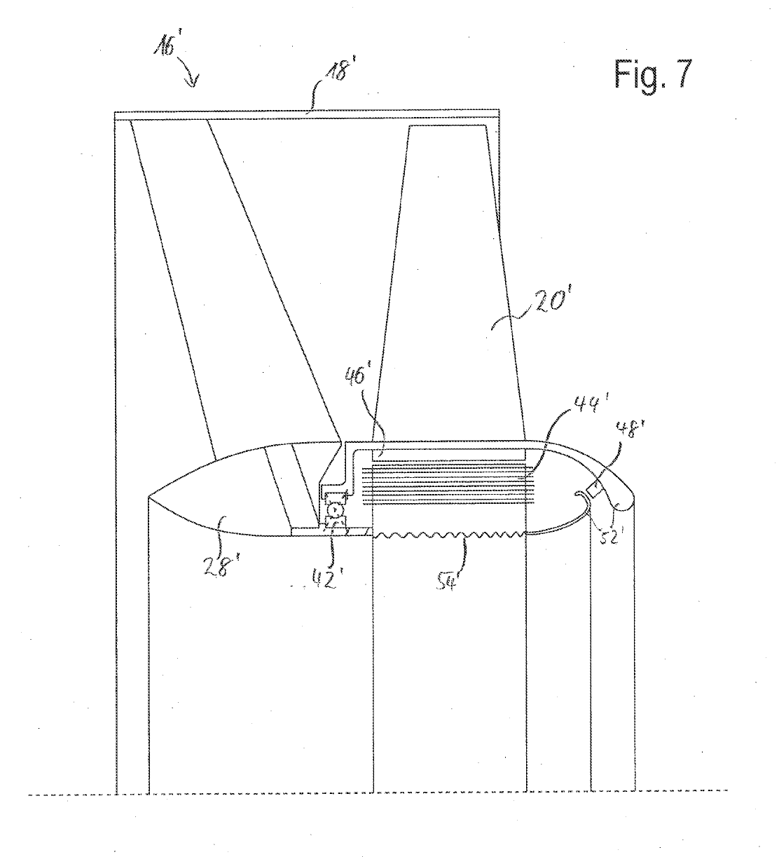

FIG. 7 is a longitudinal section through an electrically driven ducted propeller in accordance with a second embodiment;

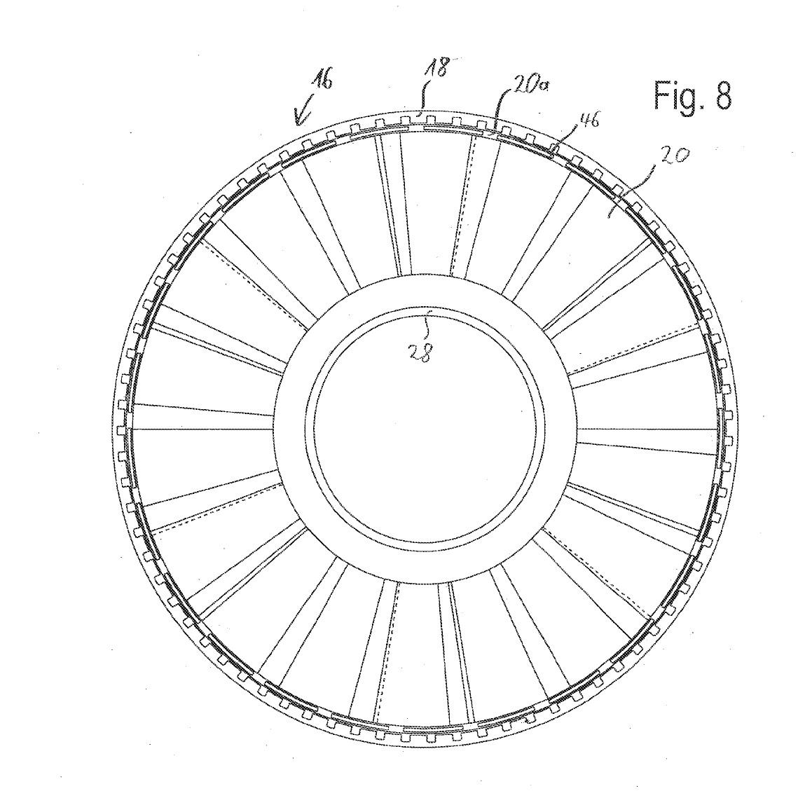

FIG. 8 is a cross-sectional view through the electrically driven ducted propeller of FIG. 6 along the line VIII-VIII;

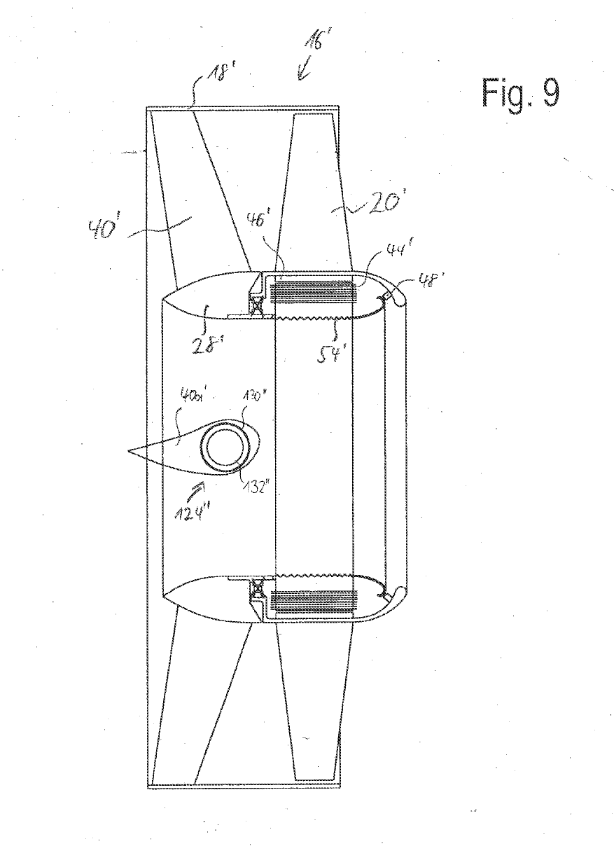

FIG. 9 is a longitudinal section through an electrically driven ducted propeller in accordance with a third embodiment;

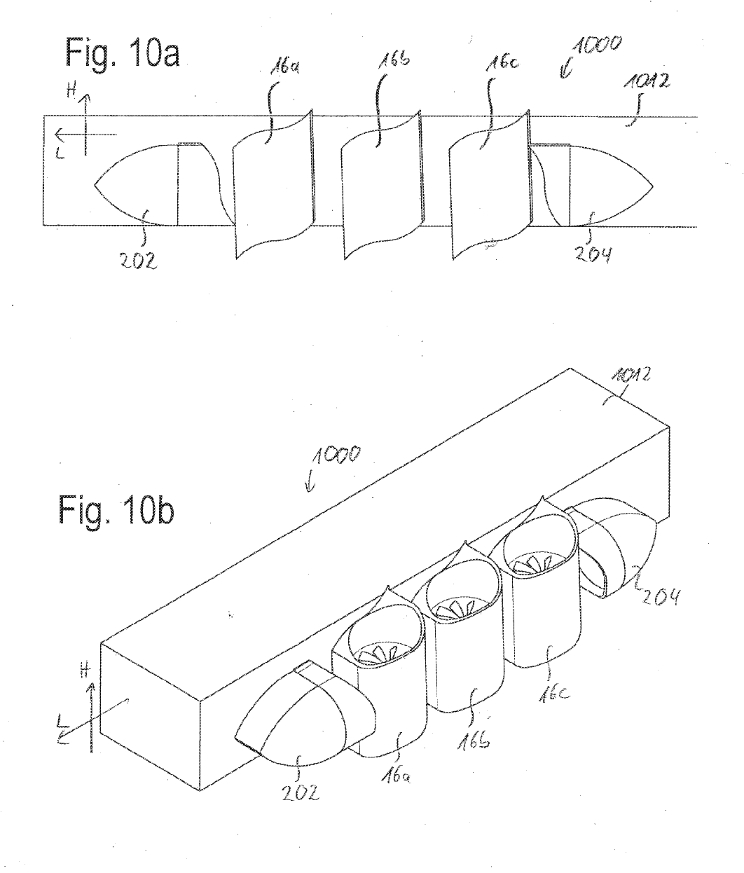

FIGS. 10a and 10b are a schematic side view and oblique view of a row of ducted propellers of a flying object according to the invention in a vertical flight position;

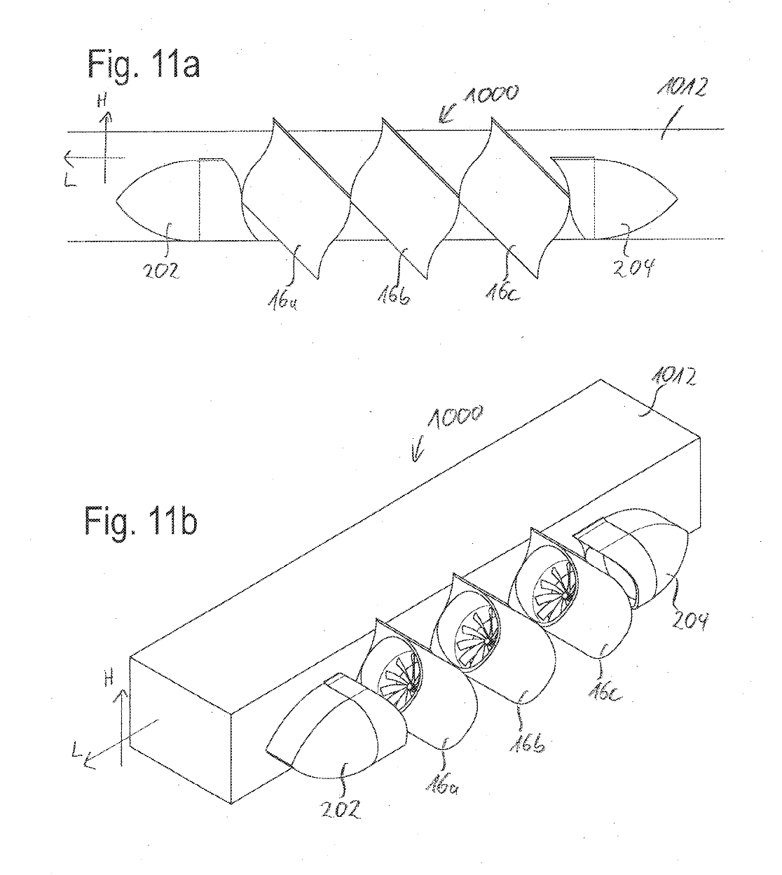

FIGS. 11a and 11 b are a schematic side view and oblique view of a row of ducted propellers of a flying object according to the invention in a transition position from vertical flight to horizontal flight;

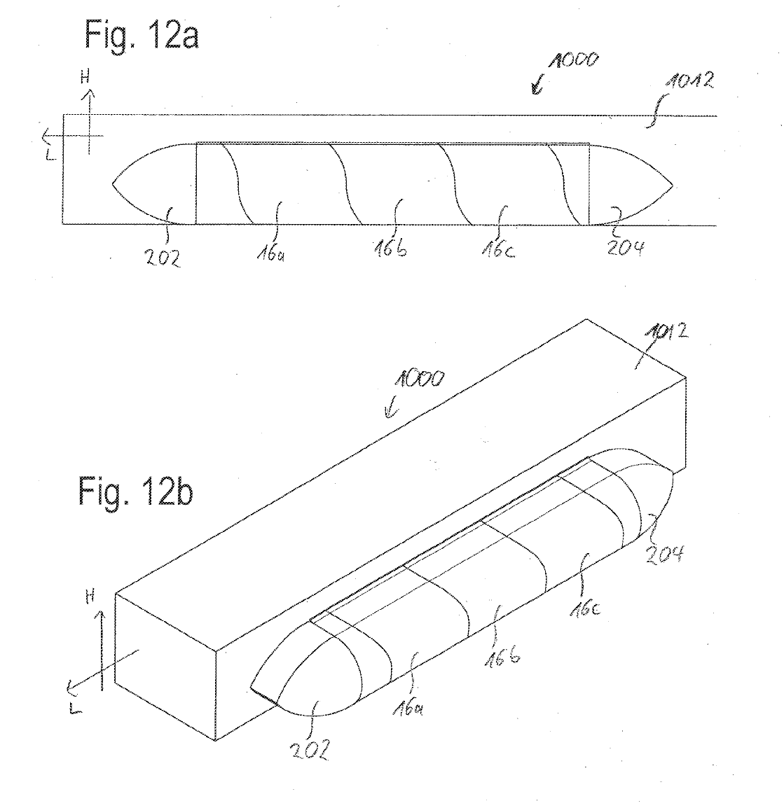

FIGS. 12a and 12b are a schematic side view and oblique view of a row of ducted propellers of a flying object according to the invention in a horizontal flight position;

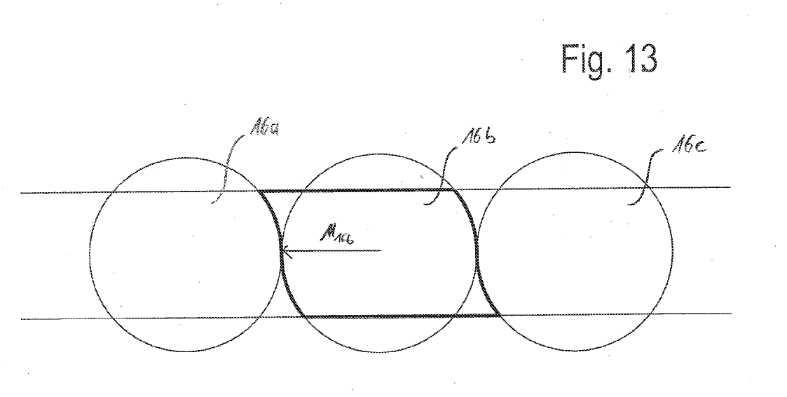

FIG. 13 is a schematic drawing of the geometric construction of the base faces of the ducts of ducted propellers in a flying object according to the invention;

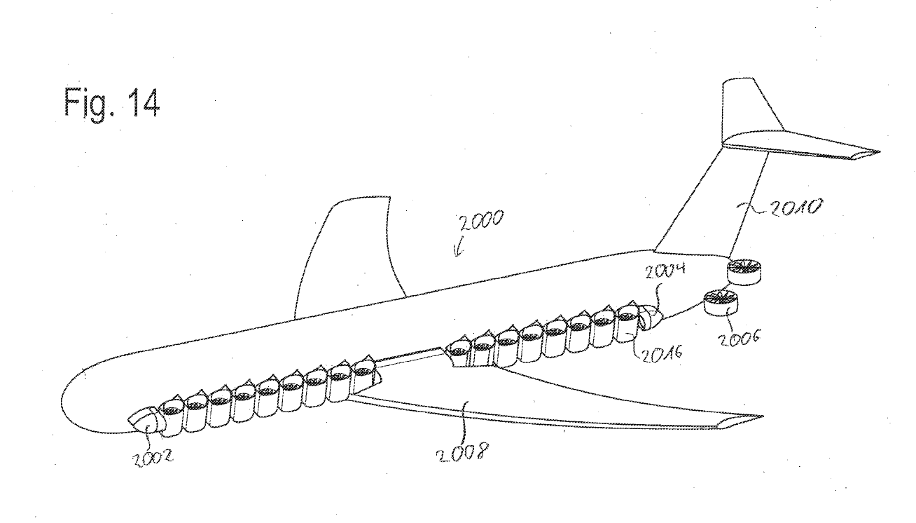

FIG. 14 is a schematic drawing of a first embodiment of a flying object according to the invention in a vertical flight configuration;

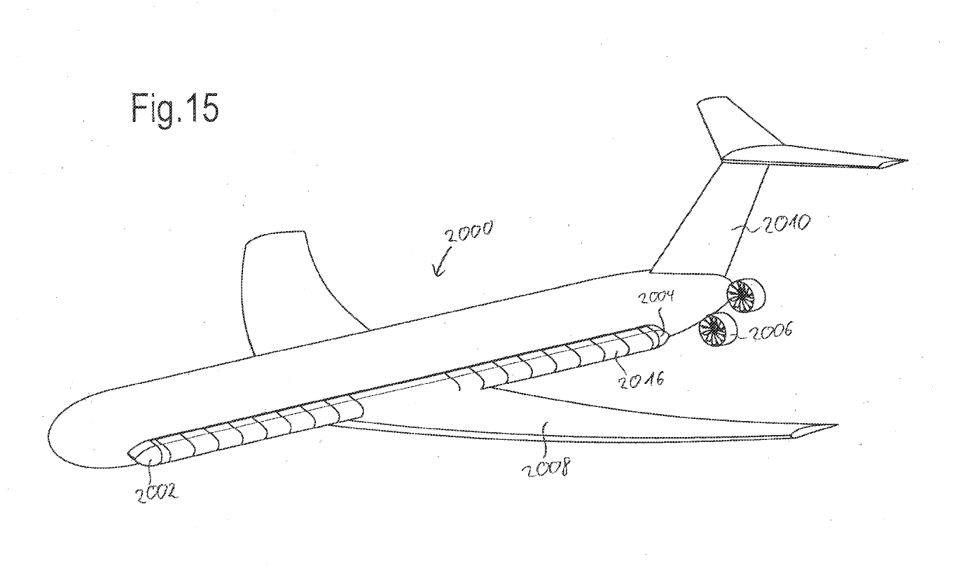

FIG. 15 is a schematic drawing of the flying object of FIG. 14 in a horizontal flight configuration;

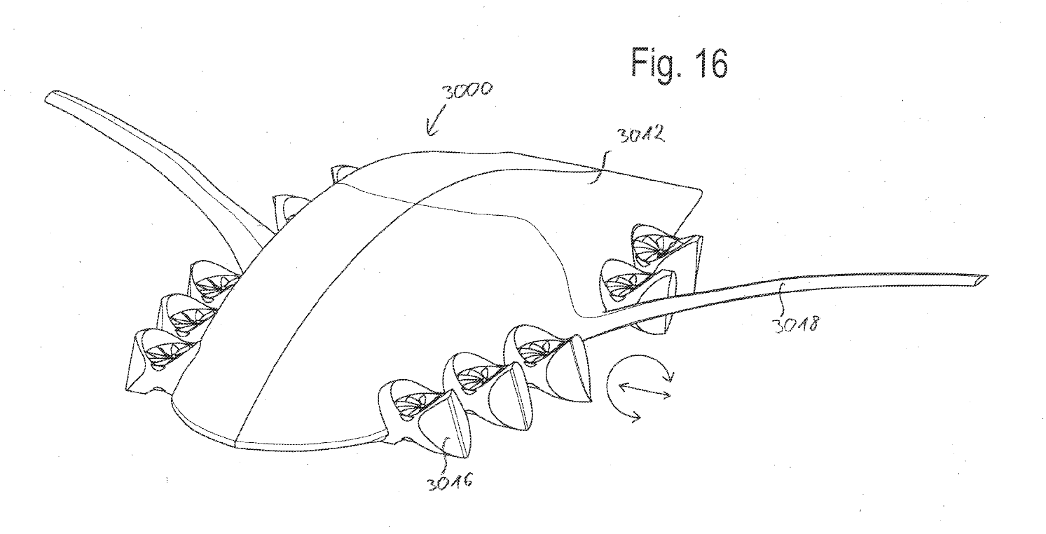

FIG. 16 is a schematic drawing of a second embodiment of a flying object according to the invention in a vertical flight configuration;

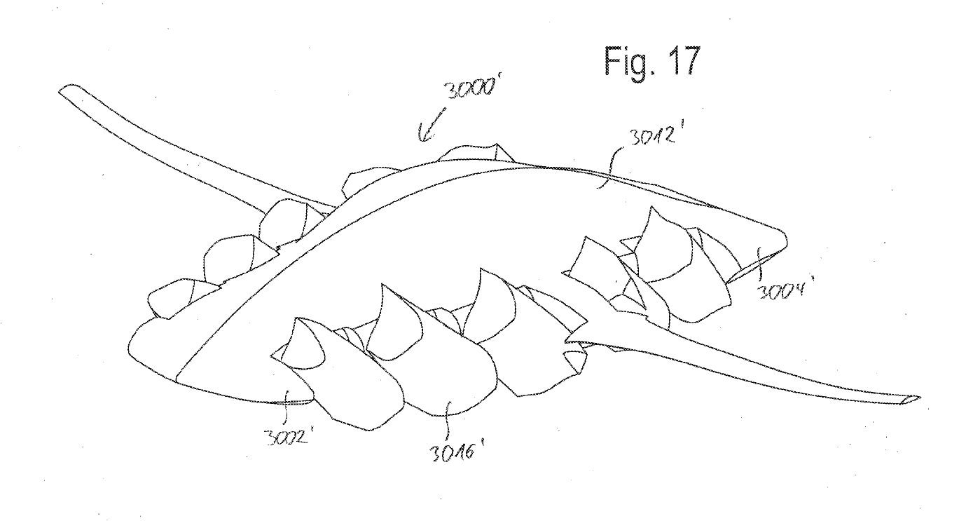

FIG. 17 is a schematic drawing of a modification of the second embodiment of the flying object according to the invention of FIG. 16 in a transition configuration from vertical flight to horizontal flight;

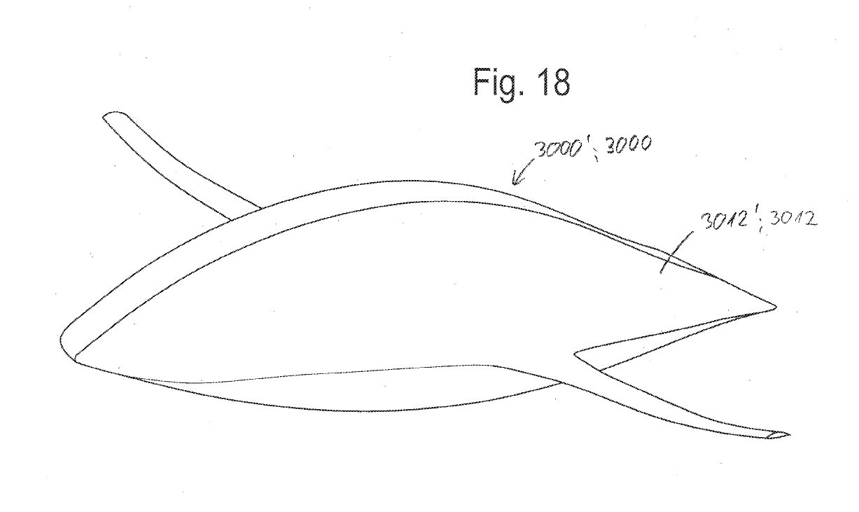

FIG. 18 is a schematic drawing of the modified embodiment of FIG. 17 in a horizontal flight configuration;

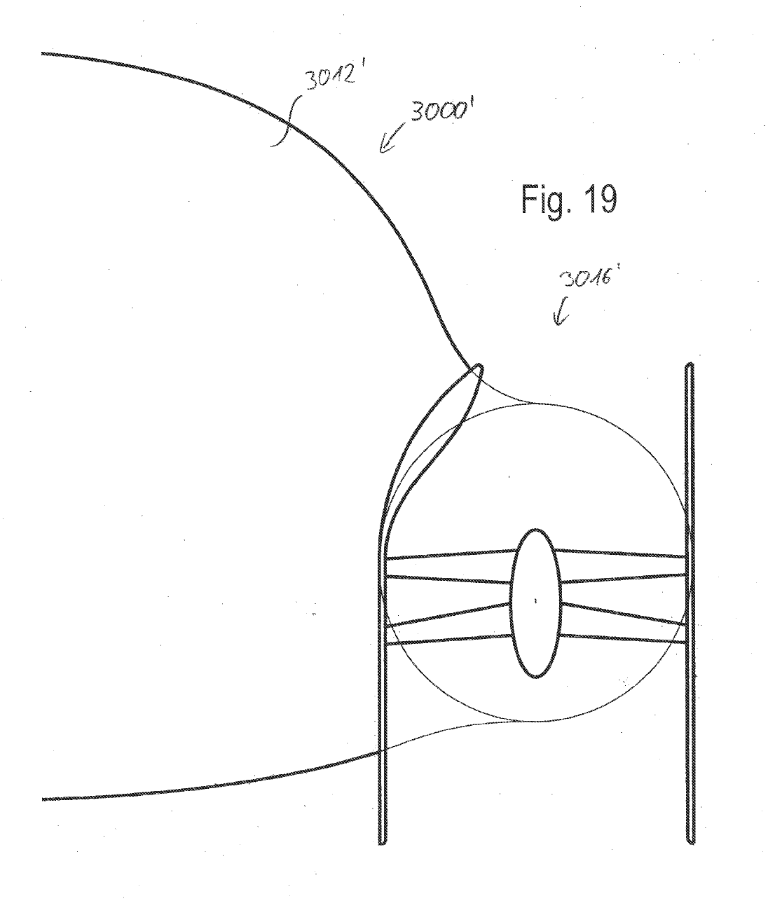

FIG. 19 is a schematic cross-sectional view of the modified embodiment of the flying object according to the invention of FIG. 17 in a vertical flight configuration;

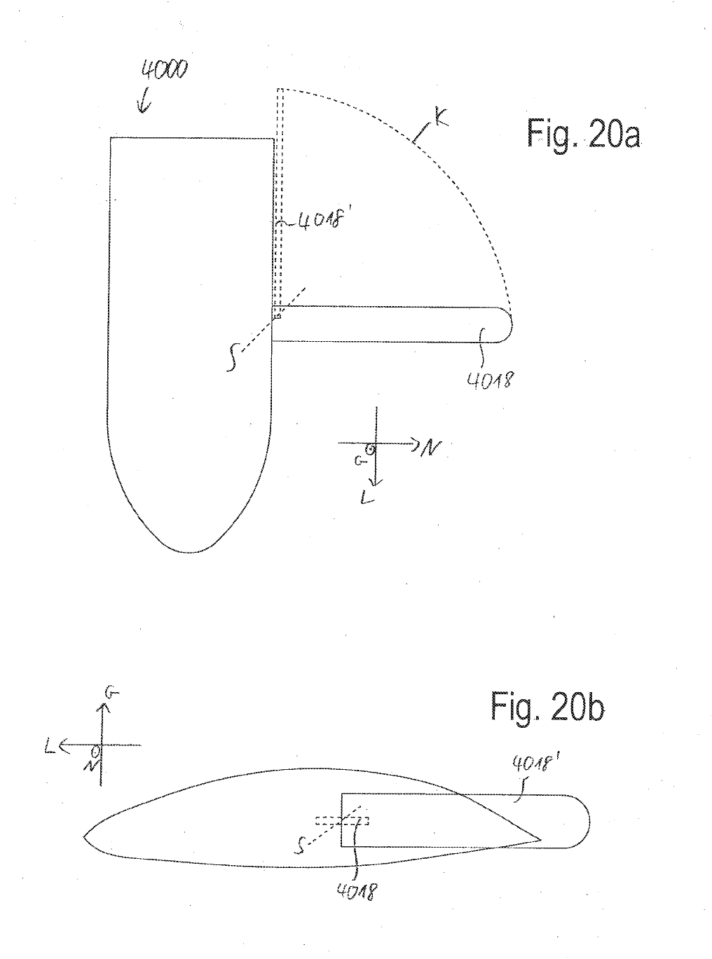

FIGS. 20a and 20b are a schematic plan view and side view of a wing folding mechanism in a flying object according to the invention;

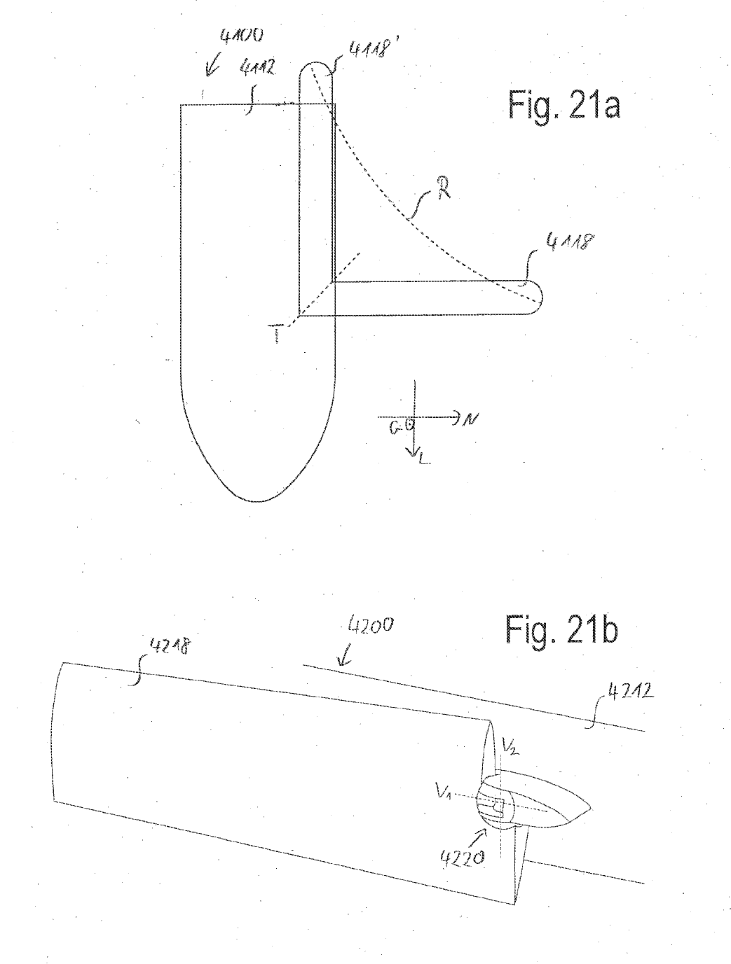

FIG. 21 a is a plan view of a flying object according to the invention having a modified wing folding mechanism;

FIG. 21b is a schematic side view of a flying object according to the invention having a third embodiment of a wing folding mechanism; and

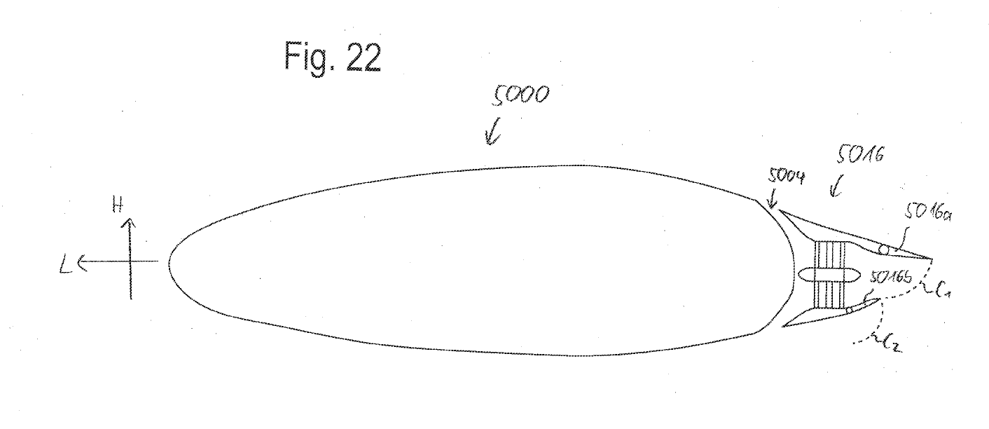

FIG. 22 is a schematic drawing of a flying object according to the invention comprising a ducted propeller having thrust deflection.

In FIG. 1, a mechanism according to the invention for stowing and adjusting a ducted propeller of a flying object 1 is denoted completely generally by reference numeral 10. As indicated by the pair of coordinate axes, in FIG. 1 the vertical axis H of the flying object 1 extends from bottom to top and the pitch axis N of the flying object extends from left to right. The longitudinal axis L of the flying axis extends out of the drawing.

The mechanism 10 is provided in the fuselage 12 of the flying object 1, which here is shown merely schematically on a cross-sectional view in the region of the mechanism 10 for stowing the ducted propeller. The outer skin of the fuselage 12, together with the outer profile of wings (not shown) of the flying object, forms the shell 14 of the flying object. The ducted propeller 16 is shown merely schematically in FIG. 1 and comprises a circular cylindrical duct 18, which is open at the base faces thereof, and a rotor 20 comprising a plurality of rotor blades, which is able to rotate in a plane perpendicular to the longitudinal axis, defined by the duct 18, of the ducted propeller. For this purpose, the rotor 20 is driven by a drive device (not shown).

A receiving chamber 22, into and out of which the ducted propeller 16 can be pivoted about the first pivot axis 24, is provided in the fuselage 12 of the flying object 1. The pivot axis 24 extends parallel to the longitudinal axis L of the flying object outside the duct 18 of the ducted propeller 16. During pivoting about the first pivot axis 24, a central longitudinal axis M of the ducted propeller 16 follows the dashed line S1 and the outermost point, opposite the first pivot axis 24, of the duct 18 of the ducted propeller 16 follows the dashed line S2. In this context, the state shown in FIG. 1 represents a deployed state of the ducted propeller 18, whilst the dashed circle denoted by reference numeral 18′ represents the position of the ducted propeller 18 in a stowed state. As can clearly be seen, the dashed circle 18′ is located completely inside the shell 14 of the flying object.

In the state shown in FIG. 1, the ducted propeller 18 is in a deployed state, in which the longitudinal axis M thereof is parallel to the longitudinal axis L of the flying object 1. As is indicated by a curved arrow in the drawing, the ducted propeller 16 is further pivotable about a second pivot axis 26, which is also shown dashed. Since this second pivot axis 26 is perpendicular both to the longitudinal axis L and to the vertical axis H of the flying object 1 in FIG. 1, it extends exactly parallel to the pitch axis N of the flying object 1. Thus, as a result of pivoting about the second pivot axis 26, the longitudinal axis M of the ducted propeller can be pivoted with respect to the longitudinal axis L of the flying object in such a way that the thrust generated by the rotor 20 of the ducted propeller 16 can be divided between an effect in a horizontal direction and a vertical direction in accordance with the pivot angle of the longitudinal axis M of the ducted propeller with respect to the longitudinal axis L of the flying object. If for example the longitudinal axis M of the ducted propeller is pivoted through 90 degrees with respect to the longitudinal axis L of the flying object with respect to the pitch axis N of the flying object, the thrust of the ducted propeller 16 merely acts in a vertical direction and can be used for example for hovering or a vertical take-off of the flying object 1.

In the stowed state of the ducted propeller, a cover element (not shown) may further cover the receiving chamber 22, following the shape of the shell 14 of the flying object 1.

FIG. 2 shows a second embodiment of a mechanism according to the invention for stowing a ducted propeller in a flying object 100, comprising a fuselage 112 and a shell 114. By contrast with the embodiment shown in FIG. 1, in the mechanism 110 in accordance with the second embodiment, the ducted propeller 116 is not pivoted so as to transfer it from the stowed state within the receiving chamber 122 into a deployed state, but instead is displaced linearly out of the receiving chamber 122 using a retraction/deployment mechanism 124. In this context, the displacement extends through one deployment mechanism 124 parallel to a pitch axis N of the flying object 100, in such a way that during pivoting about the axis 126 the option described in the context of FIG. 1 for dividing the thrust generated by the ducted propeller 116 between the vertical and the horizontal is provided again. Similarly to FIG. 1, in FIG. 2 the outline of the duct 118 in the stowed state is also shown dashed and denoted by reference numeral 118′. In this context, part of the duct 118 forms part of the shell 14, additional projections 118a being provided which provide a transition, which is advantageous in terms of flow, of the shell 114 in the region between the fuselage and the stowed ducted propeller 116. Three possible embodiments of a retraction/deployment mechanism 124 are shown in FIGS. 3 to 5.

In this context, the embodiment shown in FIG. 3 of the retraction/deployment mechanism 124 comprises a hollow rod 132 which is rotationally engaged with the fuselage 112 of the flying object 100 and which passes through the ducted propeller 116, extending within a sheath 133 which is rigidly connected to the stator shaft 128 and the duct 118. A sliding layer 133a is provided on the inner face of the sheath 133, and facilitates the relative movement of the sheath 133 and thus also of the ducted propeller 116 with respect to the hollow rod 132. In turn, a rod 130, which is rotationally engaged with the duct 118 and a stator shaft 128 of the ducted propeller 116, is received within the hollow rod 132. The hollow rod 132 and the rod 130 received therein are connected rotatably with respect to one another by means of a nut 134 and a ball bearing 139, the nut 134 cooperating with a thread, indicated on the outer face of the received rod 130, in the manner of a spindle drive. A rotational movement of the nut 134 on the thread of the hollow rod 132 is brought about by at least one servo motor 135 and causes a translational movement of the ducted propeller 116. So as to prevent rotation of the ducted propeller 116 with respect to the fuselage 112, two slots are provided in the sliding layer 133a of the sheath 133, of which for reasons of clarity only one slot 136 is shown, in which a guide element 137 associated with the hollow rod 132 is guided. As a result of the curvature of the slot 136, for a particular covered distance of the relative movement between the hollow rod 132 and the sheath 133, a rotation of the sheath 133 with respect to the hollow rod 132 is triggered, and this in turn corresponds to a rotation of the ducted propeller 116 with respect to the fuselage 112. As a result of the retraction/deployment mechanism being provided in the region of the stator shaft 128, the thrust forces occurring as a result of the operation of the ducted propeller 116 can be transmitted in a suitable manner to the retraction/deployment mechanism 124 and thus to the fuselage 112 of the flying object 100.

FIG. 4 shows an alternative embodiment of a retraction/deployment mechanism 124′ for a ducted propeller 116′, which also comprises a duct 118′ and a stator shaft 128′ and which is displaceable relative to a fuselage 112′ of the flying object by means of the retraction/deployment mechanism 124′. By contrast with the embodiment shown in FIG. 3, in the embodiment shown in FIG. 4 the relative movement between the ducted propeller 116′ and the fuselage 112′ is not achieved by means of servo motors acting directly on the nuts 134′, but rather in that a shaft 138′ is set in a rotation, represented by the curved arrow shown in FIG. 4, which is brought about by a servo motor (not shown). In this context, a hollow rod 132′ rigidly connected to the fuselage 112′ is again guided in a sheath 133′ rigidly connected to the duct 118′ of the ducted propeller 116′, but in this case the sliding layer 132a′ and the slot 136′ are associated with the hollow rod 132′ and the guide element 137′ is associated with the sheath 133′. The shaft 138′ is connected by means of a nut 134′ to the rod 130′ which is rigidly connected to the ducted propeller 116′, the nut 134′ being positioned on a thread (not shown) on the outer face of the rod 130′ and thus forming a spindle drive. Since, as discussed, the sheath 133′ which is rigidly connected to the ducted propeller 116′ is guided in the guide groove 136′ of the hollow rod 132′ by means of the guide element 137′, a rotation of the ducted propeller 116′ relative to the fuselage 112′ is prevented and the rotation of the shaft 138′ is converted into a propulsion of the ducted propeller with respect to the fuselage 112′. Again, the slot 136′ is curved in a particular distance range in such a way that in this distance range further deployment of the ducted propeller 16′ is additionally converted into pivoting of the ducted propeller 116′.

Again, in FIG. 4 the retraction/deployment mechanism 124′ is provided in the region of the stator shaft 128′, and in this embodiment too this makes possible an advantageous transmission of the thrust generated by the ducted propeller 116′ to the flying object. In addition, by comparison with the embodiment shown in FIG. 3, the blocking of the flow cross section is reduced in the deployed state of the ducted propeller 116′.

The embodiment shown in FIG. 5 of a retraction/deployment mechanism 124″ differs from the embodiment shown in FIG. 4 in the shape of the duct 118″ of the ducted propeller 116″. In the embodiment shown, this duct 118″ is of an “double cylinder shape”, in other words the shape thereof meets the broad definition of the term “cylinder” used in this application both in terms of the longitudinal axis thereof and in terms of the axis extending along the retraction/deployment direction. For illustration, reference should be made to FIG. 16 as described below. This shaping makes it possible to pivot the ducted propeller 116″ even when part of the duct 118″ thereof is still located within the receiving chamber 122″. This has in particular the advantage of not having to deploy the duct 118″ completely from the fuselage 112″ during operation of the ducted propeller 116″, and this in turn makes it possible to transmit the thrust generated by the ducted propeller 116″ to the fuselage 112″ directly via the duct 118″ and force transmission elements 141″ provided thereon, which may for example be formed as a peripheral ring about the duct 118″.

The embodiment shown in FIG. 5 of a retraction/deployment mechanism 124″ further differs in the arrangement of the drive thereof and the shaping of the slot 136″. In this case, the servo motor provided for deploying the ducted propeller 116″ is associated directly with the element 140″ running in the slot 136″, and converts a rotation of the element 140″ within the slot 136″ into a translational movement of the ducted propeller 116″ for example by way of a rack and pinion mechanism. In this context, the slot 136″ in FIG. 5 comprises a region 136a″, which is parallel to the retraction/deployment direction and thus provides the actual retraction/deployment of the ducted propeller 116″, and a region 136b″, which is perpendicular to the region 136″ and which merely provides the pivoting of the ducted propeller 116″.

The hollow rod 130″ of the retraction/deployment mechanism shown in FIG. 5 extends within a blade of the stator. The rod 132″ is further formed in such a way, in terms of the length thereof, that it only protrudes into the interior of the stator shaft 128″ in the retracted state and the interior of the stator shaft 128″ is thus free of components in the deployed state.

By contrast with the embodiments shown in FIGS. 3 and 4, this embodiment makes it possible to decouple the translational movement and the pivoting movement of the ducted propeller virtually completely, and thus to be able to set the angle of attack of the ducted propeller 116″ particularly precisely. Further, the “double cylinder shape” of the duct 118″ ensures excellent aerodynamic properties of the flying object in every position of the ducted propeller 116″.

FIG. 6 is a cross section of an electrically driven ducted propeller 16 according to the invention, merely the upper half of the ducted propeller 16 being shown in FIG. 6. A corresponding ducted propeller 16 may, among other things, be used together with the mechanisms shown in FIGS. 1 to 5. The ducted propeller 16 comprises a substantially circular cylindrical duct 18 and a stator 40, rotationally engaged with the duct and comprising a plurality of stator blades of which only one is shown here. In the radially inner region of the stator 40, a stator shaft 28 is rotationally engaged therewith. A rotor 20 is mounted on the stator shaft 28 rotatably with respect to the stator shaft 28 by means of a four-point bearing 42, likewise only one of the ball bearings being shown here in FIG. 6. The four-point bearing 42 is positioned along a peripheral line of the stator shaft 28 and merely one four-point bearing 42 is required so as to mount the rotor rotatably on the stator shaft 28. On the inner face of the duct 18, a plurality of coils 44 are provided, which are rotationally engaged with respect to the duct 18 and which cooperate with magnets 46 provided in the rotor 20 in such a way that they form a brushless synchronous motor. Additional blades 48 are attached in the radially outer end region of the rotor 20, and ensure that, during operation of the rotor 20, part of the air sucked in by the rotor 20 is deflected to the coils 44, causing the coils 44 to be cooled effectively by the air deflected towards them. For this purpose, additional air ducts 50 are provided between the duct 18 and the coils 44. The air sucked in by the additional blades 48 thus flows through the ducts 50 in part and through the intermediate space between the coils 44 and the rotor 20 in part. A ring is provided on the radially outer end of the rotor 20 (see FIG. 8) and interconnects the individual rotor blades at the ends thereof. The magnets 46 are received in this ring in part. To counter the risk that in particular foreign substances sucked in by the additional blades 48, such as sand, may damage the coils 44, a deflector element 52 is provided in the front region of the ducted propeller and effectively deflects foreign substances which are sucked in towards the rotor blades 20, which are much less sensitive to foreign substances of this type than the coils 44.

In the embodiment shown, the stator shaft 28 is formed as a hollow shaft and part of the air sucked in by the rotor 20 is passed through this hollow shaft 28 during the operation of the ducted propeller 16.

FIG. 7 shows an alternative embodiment of an electrically driven ducted propeller 16′ according to the invention. In this context, in this this embodiment the coils 44′ are not provided on the duct 18′, but rather connected to the stator shaft 28′. This is thus an external rotor motor. Consequently, the magnets 46′ associated with the rotor 20′ are arranged radially internally in this embodiment. In the configuration shown in FIG. 7 of the ducted propeller 16′ according to the invention, a single four-point bearing 42′ may again be provided along an individual peripheral line of the stator shaft 28′ which is supported by the stator 40′. In turn, additional blades 48′ are provided in the front region of the rotor 20′, and divert part of the airflow sucked in by the rotor 20′ towards the coils 44′ for cooling. In addition, to improve the cooling of the coils 44′ further, cooling ribs 54′ are arranged on the open inner face of the hollow stator shaft 28′. In the embodiment shown in FIG. 7, the deflector element 52′ is formed by the cooperation of the front parts of the rotor 20′ and the stator shaft 28′.

FIG. 8 again shows the ducted propeller 16 of FIG. 6, in a cross section along the dashed line denoted as VIII in FIG. 6. This drawing merely serves to illustrate the ring 20a which connects the rotor blades of the rotor 20 at the outer ends thereof and in which the magnets 46 are received. Further elements, such as the duct 18 and the stator shaft 28, are merely shown schematically, whilst any illustration of the coils 44 has been completely omitted.

FIG. 9 shows a combination of a retraction and deployment mechanism 124″ for a ducted propeller, such as is shown for example in FIG. 5, with the embodiment of a ducted propeller 16′ shown in FIG. 7. Reference should therefore be made to FIG. 7 for the names of the shown elements of the ducted propeller 16′. As can be seen in FIG. 9, the hollow rod 130″ and the rod 132″ are arranged in the region of the stator blades of the stator 40′ of the ducted propeller 16′ and extend through a stator blade 40a′. In the deployed state of the ducted propeller 16′, the interior of the stator shaft 28′ is further completely free of components, since as discussed in connection with FIG. 5 the rod 132″ does not protrude into the stator shaft 28′.

FIGS. 10a and 10b schematically show a row of ducted propellers which are attached to a flying object 1000 according to the invention, the longitudinal axis L and vertical axis H of which are indicated by pairs of coordinate axes. The ducted propellers are denoted by reference numerals 16a, 16b and 16c. They are arranged in a row along a fuselage 1012 of the flying object 1, the fuselage 1012 merely being shown schematically. The row of ducted propellers 16a to 16c is provided with a start element 202 at the front end thereof and with an end element 204 at the rear end thereof. In FIGS. 10a and 10b, the longitudinal axes of the ducted propellers 16a to 16c are each in a vertical position, in which they generate a vertical thrust during operation. As can be seen in FIG. 10a, the profiles of the ducts of the ducted propellers 16a to 16c are formed S-shaped in the region of the base faces thereof.

In FIGS. 11a and 11b, the longitudinal axes of the ducted propellers 16a to 16c are inclined at approximately 45 degrees towards the start element 202 by comparison with FIGS. 10a and 10b. In this configuration, the thrust generated by the operation of the ducted propellers 16a to 16c acts in equal parts in the horizontal and in the vertical direction. In a flying object according to the invention, this configuration is taken on during the transition from hovering to cruising, for example between a vertical take-off and substantially horizontal cruising.

Finally, FIGS. 12a and 12b show a configuration of the ducted propellers 16a to 16c in which the longitudinal axes thereof are parallel to the longitudinal axis of the flying object 1000. The ducts of the ducted propellers 16a to 16c transition seamlessly into one another and are delimited by the start element 202 at the front end and by the end element 204 at the rear end, flowing transitions being achieved here too. Since the base faces of the ducts of the ducted propellers 16a to 16c are covered in this state, the ducted propellers 16a to 16c are not in operation in FIGS. 12a and 12b, meaning that they cannot contribute to the lift or propulsion of the flying object. This configuration is suitable for example for cruising of the flying object 1000 in which the propulsion is provided by additional thrust-generating elements (not shown) whilst the lift is achieved by corresponding wing profiles.

For reasons of aerodynamics, in the configuration shown in FIG. 12 of the ducted propellers 16a to 16c a boundary layer suction system may be provided to reduce eddies of the air on the outer face of the ducted propellers 16a to 16c. For this purpose, it is necessary to provide small spaces or slits between the ducts of the ducted propellers 16a to 16c in the configuration shown, although said propellers are still understood to fall within the “seamless transition” concept of the present application. By now operating at least one of the ducted propellers, in particular the rearmost ducted propeller 16c, at a low rotational speed even during cruising, swirling of the air on the outer face of the ducted propeller 16a to 16c can effectively be prevented, since the air now flows into the internal region of the ducted propellers 16a to 16c in a controlled manner. If the boundary layer suction device is provided, it is further necessary to provide an opening, through which the air sucked in can exit again, in the end element 204.

FIG. 13 is a schematic drawing showing how the S-shaped profiles of the ducts of the ducted propellers 16a to 16c have been constructed. In each case, the peripheries of the central longitudinal axes of the ducted propellers about the pitch axis of the flying body or the transverse axes of the ducted propellers are shown, in this case merely represented by the central longitudinal axis M_{16b} of the ducted propellers 16b. If these peripheries are followed as shown by the thicker line in FIG. 13, S-shaped profiles are obtained for the base faces of the cylindrical ducts of the ducted propellers 16a to 16c, which make a continuous transition of the ducts possible and also make rotation of the individual ducted propellers 16a to 16c with respect to one another about the geometric centres thereof possible in each case, without the casings obstructing one another.

FIG. 14 shows a first embodiment of a flying object 2000 in which ducted propellers 2016, arranged in a row, are arranged in a configuration corresponding to the arrangement of the ducted propellers 16a to 16c in FIGS. 10 to 12. Again, the rows of ducted propellers 2016 are each provided with a start element 2002 and an end element 2004. Further, additional ducted propellers 2006 are provided on the tail of the flying object, and are suspended independently of the rows of ducted propellers 2016. In the configuration shown in FIG. 14, the flying object 2000 according to the invention is in a state in which all of the ducted propellers 2016 merely contribute to the lift of the flying object 2000, and this can for example make a vertical take-off possible. The flying object 2000 substantially corresponds in form and configuration to a known passenger aircraft having an elongate fuselage, which defines a longitudinal axis of the aeroplane 2000, as well as a pair of wings 2008, attached to this fuselage, and a tail unit 2010.

FIG. 15 again shows the flying object 2000 according to the invention of FIG. 14, but in this case the rows of ducted propellers 2016 are in a configuration corresponding to the position of the ducted propellers 16a to 16c in FIGS. 12a and 12b. In this context, the longitudinal axes of the ducted propellers 2016 are orientated parallel to the longitudinal axis of the flying object 2000 and not in operation. The propulsion of the flying object 2000 is merely ensured by the additional ducted propellers 2006, the longitudinal axes of which are likewise orientated parallel to the longitudinal axis of the flying object 2000. In this cruising state, the lift force of the flying object 2000 is merely achieved by the air flowing around the suitably selected profiles of the wings 2008. Thus, as discussed, in this state the flying object 2000 substantially corresponds to a known passenger aircraft.

FIG. 16 shows an alternative embodiment of a flying object 3000 according to the invention. It comprises a fuselage 3012 and a pair of wings 3018 as well as two rows of ducted propellers 3016, which may each correspond in particular to the ducted propellers shown in FIG. 5 each comprising a corresponding associated retraction/deployment mechanism. The flying object 3000 is a “fuselage-wing aircraft”, in which not only the wings 3018 contribute to the lift of the flying object 3000 in horizontal flight, but the fuselage 3012 is also profiled in such a way that it contributes to the lift of the flying object 3000 in horizontal flight. As is indicated by the arrows in FIG. 16, the individual ducted propellers 3016 in the fuselage of the flying object 3000 can be lowered and the longitudinal axes thereof can be pivoted with respect to the pitch axis of the flying object 3000. Suitable devices for achieving this deployment and pivoting may be either the mechanisms shown in FIGS. 1 and 2 or in particular the mechanism shown in FIG. 5 comprising ducted propellers 3016 in the form of a double cylinder, having the advantages discussed above.

FIG. 17 shows a modified embodiment 3000′ of the flying object shown in FIG. 16. By contrast with FIG. 16, in the flying object 3000′ shown in FIG. 17 the ducted propellers 3016′ are not lowered in the fuselage 3012′ for horizontal flight, but rather the ducts thereof themselves form part of the fuselage 3012′. This configuration thus substantially corresponds to the arrangement shown in FIGS. 10 to 12 of the ducted propellers 3016′ comprising a start element 3002′ and an end element 3004′. In this context, the outer shape of the casings of the ducted propellers 3016′ deviates to some extent from a strictly geometric cylindrical shape, so as to be able to follow the fuselage shape of the fuselage-wing aircraft 3000′. However, as discussed above, the shape thereof still falls within the “cylinder” concept used in the present application.

The flying object 3000′ according to the invention of FIG. 17 is shown again in FIG. 18, this time in a configuration for horizontal flight. It should be noted that FIG. 18 also shows the flying object 3000 of FIG. 16, since the two flying objects 3000 and 3000′ have identical shell shapes in horizontal flight. As discussed, the linear longitudinal axes are integrated into the profile of the fuselage-wing aircraft parallel to the longitudinal axis of the flying-object-orientated ducted propeller 3016′, in such a way that a suitable aerodynamic shape of the flying object 3000′ is achieved, or the individual ducted propellers 3016 are lowered in the fuselage 3012, in a manner resulting in an identical shape of the flying object 3000.

FIG. 19 shows the flying object 3000′ according to the invention of FIGS. 17 and 18 again in a cross section extending transversely through the fuselage 3012′ in the region of a ducted propeller 3016′. In this context, it can be seen in FIG. 19 that the ducted propeller 3016′ also deviates from a purely geometrical cylinder shape in the longitudinal profile thereof, in such a way that together with the fuselage 3012′ a smooth outer line or shell of the flying object 3000′ can be achieved.

FIGS. 20a and 20b show a flying object 4000 according to the invention, which has a longitudinal axis L, a pitch axis N and a yaw axis G. A wing 4018 is pivotably attached to the flying object 4000, the pivot axis S being provided directly on the attachment of the wing 4018 and being inclined through 45 degrees with respect to each of the primary axes L, N and G, specifically rearwards, upwards and outwards. During folding, the tip of the wing 4018 follows the curve K shown in FIG. 20a, and in the folded state said wing is in the position represented by the dashed outline 4018′ in FIG. 20a and the outline 4018′ shown in FIG. 20b. In this context, the wing 4018 has further been tilted from a horizontal orientation into a vertical orientation.

FIG. 21a shows a modified embodiment of the flying object 4100 shown in FIGS. 20a and 20b. The modified flying object 4100 comprises a wing 4118. The longitudinal, pitch and yaw axes of the flying object 4100 in FIG. 21 are arranged corresponding to the respective axes of the flying object 4000 in FIG. 20a. In the modified embodiment in FIG. 21, the wing folds in about an axis T, which is in the plane of the longitudinal axis L and the pitch axis N and which is at an inclination of 45 degrees to each of the two axes. During folding in about the axis T, the tip of the wing 4118 covers the curve R shown in dashes, and is transferred into the position denoted as 4118′. Since the advance region of the axis T is within the fuselage 4112 of the flying object 4100, in the position 4118′ the wing 4118 is received substantially in the fuselage or in the region of the fuselage of the flying object 4100 below or above it.

FIG. 21b is a side view of a third embodiment of the flying object 4200 shown in FIGS. 20a and 20b comprising at least two wings, of which only a single wing 4218 is shown, and a fuselage 4212. In this context, the wing 4218 is folded rearwards or forwards by means of two articulations configured as a double articulation 4220. The first axis V₁ is positioned in the wingspan direction of the wing 4218 and the second axis V₂ is positioned perpendicular to the first axis V₁, parallel to the yaw axis of the flying object 4200. To fold the wing 4218, it is initially pivoted through 90° about the first axis V₁ and subsequently rearwards about the second axis V₂. The double articulation 4220 is constructed from two floating bearings consisting of two tubes connected in a T shape. The advantage of this arrangement is that it is possible to dispense with additional force receiving elements such as securing bolts during flight, since the two articulations are each loaded with bending moments perpendicular to the respective axis thereof during flight. The entire loads of the wing 4218 occurring during flight are transferred via the articulations. As a result, the wing 4218 can be set freely in terms of the angle of attack thereof during flight. Since the wing 4218 can be aligned during flight, it is possible to dispense with ailerons in the wing 4218. To roll the flying object 4200, the at least two wings of the flying object 4200 are rotated slightly with respect to one another. The first axis of rotation V₁ of the wing 4218 is used both as an aileron and for folding the wing 4218.

During slow flight, the wing 4218 can be inclined slightly downwards relative to the fuselage 4212 together with a nose of the fuselage. This has the advantage that the angle of attack of the fuselage 4212 can be set independently of the angle of attack of the wing 4218. Thus, the fuselage 4212 can take on a very high angle of attack during slow flight and generate a large amount of lift without the wing 4218 also having to be aligned.

The double articulation 4220 may also be arranged rotated through 90° in the fuselage, in such a way that the wing 4218 is folded upwards.

The variant of the wing folding in which only one axis is used, which is at an inclination of approximately 45° in each case to all three aeroplane axes, can be constructed in such a way that all of the flight loads are transferred via the articulation and the wing can be pivoted during flight. In this case too, ailerons can be dispensed with.

Finally, FIG. 22 shows a flying object 5000 according to the invention which is equipped with a ducted propeller 5016 which is arranged on the tail of the flying object 5000 with respect to the longitudinal axis L of the flying object. The ducted propeller 5016 is arranged on the tail of the flying object 5000 in such a way that a gap 5004 is formed through which the ducted propeller 5016 can suck in air following the profile of the flying object 5000. Further, the ducted propeller 5016 is provided with thrust deflection flaps 5016a and 5016b, which are provided pivotably on the ducted propeller 5016 in such a way that during pivoting of the diversion elements 5016a and 5016b the respective ends thereof remote from the ducted propeller 5016 follow the curves C₁ and C₂ shown in dashes. As a result of the thrust deflection by means of the thrust deflector elements 5016a and 5016b, it is possible to regulate in a highly efficient manner the thrust of the ducted propeller 5016 continuously between a vertical and a horizontal direction.

1. Mechanism for stowing and/or adjusting a ducted propeller of a flying object the flying object having a fuselage and at least one pair of wings, the outer walls of which together define a shell of the flying object, comprising:
a ducted propeller having a substantially cylindrical duct, which defines a longitudinal axis of the ducted propeller and is open at the base faces thereof, a rotor having a plurality of rotor blades, which is set up to rotate in a plane perpendicular to the longitudinal axis of the ducted propeller, and a drive device for driving the rotor;
a receiving chamber, provided in the fuselage and/or a wing of the flying object, for the ducted propeller;
a mechanism which is set up to transfer the ducted propeller from a stowed state into a deployed state;
wherein
in the stowed state the ducted propeller is received in the receiving chamber in such a way that as considered in a longitudinal direction of the flying object it is received completely within the shell of the flying object, and
in the deployed state at least the base faces of the duct of the ducted propeller are positioned outside the shell of the flying object and the longitudinal axis of the ducted propeller is tilted towards the longitudinal axis of the flying object through a variable angle, between 0° and 90°, with respect to a pitch axis of the flying object.

2. Mechanism according to claim 1, wherein the transfer mechanism comprises a first mechanism which is set up to pivot the ducted propeller about a first pivot axis which is substantially parallel to the longitudinal axis of the flying object, and a second mechanism which is set up to pivot the ducted propeller about a second pivot axis at an inclination to the first pivot axis.

3. Mechanism according to claim 2, wherein the second pivot axis is parallel to the pitch axis of the flying object.

4. Mechanism according to claim 2, wherein the ducted propeller further comprises a stator which has one or more substantially radially extending stator blades, and
the second pivot axis is arranged within the ducted propeller and in the region of the stator with respect to the longitudinal direction of the ducted propeller .

5. Mechanism according to claim 1, wherein the transfer mechanism comprises a retraction/deployment mechanism, which is set up to retract/deploy the ducted propeller radially linearly in a first direction with respect to the longitudinal axis of the flying object, and a pivot mechanism, which is set up to pivot the ducted propeller about a pivot axis which is parallel to the first direction

6. Mechanism according to claim 5, wherein the first direction is parallel to a pitch axis of the flying object.

7. Mechanism according to claim 5, wherein the retraction/deployment mechanism comprises a first support element, which is associated with the fuselage of the flying object and extends in the first direction, and a second support element, which is associated with the ducted propeller extends in the first direction and is movable a predetermined distance in the first direction relative to the first support element,
the first support element and the second support element being set up to cooperate in such a way that in the stowed state of the ducted propeller they overlap by at least a first predetermined amount with respect to the first direction and in such a way that in the deployed state they overlap by a second amount, smaller than the first predetermined amount, with respect to the first direction and transfer propulsion/lift forces generated by the ducted propeller to the flying object.

8. Mechanism according to claim 7, wherein the first and second support element are each provided with elements which cooperate in such a way that a movement of the second support element with respect to the first support element in the first direction brings about the pivoting of the ducted propeller, at least over part of the predetermined distance.

9. Mechanism according to claim 8, wherein the ducted propeller comprises a stator which has one or more substantially radially extending stator blades, and
the second support element is arranged at least in part in the region of the stator with respect to the longitudinal direction of the ducted propeller.

10. Mechanism according to claim 9, wherein the first support element is formed as a rod and the second support element as a hollow rod or the first support element as a hollow rod and the second support element as a rod, the rod being received substantially completely within the hollow rod in the stowed state.

11. Mechanism according to claim 1, wherein in the stowed state the shell of the flying object is formed at least in part by the duct of the ducted propeller and/or by a cover element in the region of the receiving chamber, the cover element optionally also forming part of the shell in the deployed state.

12. Mechanism according to claim 1, wherein the duct of the ducted propeller further substantially has a cylindrical shape with respect to a further axis perpendicular to the longitudinal axis thereof.

13. Electrically driven ducted propeller, comprising:
a duct having a substantially circular cross section, a stator rotationally engaged with the duct, the stator having one or more substantially radially extending stator blades and having on a radially inner region a shaft for supporting a rotor;
a rotor supported on the shaft rotatably with respect to the stator and the duct and having a plurality of rotor blades;
a plurality of magnets rotationally engaged with the rotor or a conductive cage rotationally engaged with the rotor;
a plurality of coils arranged rotationally engaged with respect to the stator and the duct;
wherein the rotor comprises a plurality of additional blades rigidly connected to the rotor in a radial end region,
the radial end region of the rotor facing towards the plurality of coils.

14. Electrically driven ducted propeller according to claim 13, wherein the plurality of additional blades are formed in such a way that they deflect part of the air sucked in by the rotor towards the coils in such a way that the coils are cooled by the resulting airflow.

15. Electrically driven ducted propeller according to claim 13, wherein a deflector element is provided upstream from the rotor blades with respect to the flow direction of air sucked in through the ducted propeller, and covers both the magnets or conductive cage of the rotor and the coils as considered in the flow direction, the coils being arranged in such a way that they can be flowed onto during the operation of the ducted propeller by air flowing around the deflector element.

16. Electrically driven ducted propeller according to claim 13, wherein the radially outer ends of the rotor blades are connected by a peripheral ring.

17. Electrically driven ducted propeller according to claim 16, wherein at least some of the plurality of magnets or at least part of the conductive cage is/are received in or supported by the peripheral ring.

18. Electrically driven ducted propeller according to claim 13, wherein the shaft for supporting the rotor is a hollow shaft which defines a substantially cylindrical interior which is open at both base faces.

19. Electrically driven ducted propeller according to claim 18, wherein the coils are attached to the hollow shaft and cooling ribs are provided on the radial inner face of the hollow shaft.

20. Electrically driven ducted propeller according to claim 13 wherein the rotor is supported on the shaft using a four-point bearing, said four-point-bearing being arranged along an individual peripheral circle of the shaft.

21. Flying object having vertical take-off and landing capability, comprising:
a plurality of ducted propellers, which each comprise a substantially cylindrical duct which defines a longitudinal axis of the ducted propeller and is open at the base faces thereof;
the ducted propellers each being mounted rotatably about a pitch axis of the flying object;
the ducted propellers each being able to take on a first position, in which the longitudinal axis of the respective ducted propeller is parallel to the longitudinal axis of the flying object, and a second position, in which the longitudinal axis of the respective ducted propeller is at an inclination to the longitudinal axis of the flying object by a particular angular amount;
the ducted propellers being arranged in at least one row, each row comprising a plurality of ducted propellers, in such a way that when all of the ducted propellers in a row are in the first position the ducts of the ducted propellers form an overall cylinder;
wherein in the first position the ducts of at least two of the ducted propellers in the or each row of ducted propellers follow one another without interruption along the longitudinal axes thereof.

22. Flying object according to claim 21, wherein a start element is associated with the or each row of ducted propellers in the longitudinal direction of the flying object and is formed in such a way that in the first position of the ducted propellers, as considered in the longitudinal direction of the flying object, the base face of the overall cylinder formed by the ducts of the ducted propellers is covered in a front view.

23. Flying object according to claim 21, wherein an end element is further associated with the or each row of ducted propellers in the longitudinal direction of the flying object, and is formed in such a way that in the first position of the ducted propellers, as considered in the longitudinal direction of the flying object, the base face of the overall cylinder formed by the ducts of the ducted propellers is covered in a rear view.

24. Flying object according to claim 21, wherein in each case at least one base face of each ducted propeller is formed S-shaped in a side view along the pitch axis of the flying body.

25. Flying object according to claim 21, wherein at least some of the ducted propellers are arranged directly on an outer face of a fuselage of the flying object.

26. Flying object according to claim 21, wherein at least some of the ducted propellers are arranged in a wing of the flying object, the ducts of the ducted propellers arranged in the wing preferably forming part of the wing profile in the first position.

27. Flying object according to claim 21, wherein the flying object further comprises at least one further ducted propeller and/or further devices which merely contribute to the propulsion of the flying object.

28. Flying object having vertical take-off and landing capability, comprising:
an undercarriage and at least one pair of wings, which can be slid or folded in a mode of travel of the flying object which can be implemented using the undercarriage on the base,
wherein the wings are each pivotable about an axis which is inclined by an angle of between 25° and 65° with respect to each of the primary axes of the flying object and which is provided directly on the wing attachment, or in that the wings are each pivotable about an axis which is positioned in the fuselage of the flying object and which is positioned in the plane spanned by the longitudinal axis and the pitch axis and which is tilted in each case through an angle of between approximately 25° and approximately 65° towards the longitudinal axis and the pitch axis of the flying object, or
in that the wings can be folded inwards into the fuselage, the fuselage being sealable by sealing elements, or
in that the wings are retractable into the fuselage by means of a slide arrangement, or
in that the wings are pivotable forwards or backwards using two articulations configured as a double articulation, a first pivot axis being positioned along a wingspan direction of the wing and a second pivot axis being positioned perpendicular to the first pivot axis parallel to the yaw axis of the flying object, and the wing, for folding in, initially being pivoted through 90° about the first pivot axis and subsequently being pivoted forwards or backwards about the second pivot axis.

29. Flying object having vertical take-off and landing capability, comprising:
at least one ducted propeller, which is arranged in such a way that it is completely covered by a fuselage and/or a wing of the flying object in a front view of the flying object along the longitudinal axis of the flying object, wherein
the ducted propeller is provided with controllable elements for thrust deflection, in such a way that in operation the ducted propeller can selectively contribute to the propulsion or lift or both to the propulsion and to the lift of the flying object.
